(19) United States
(12) Patent Application Publication
(10) Pub. No.: US 2014/0013906 A1
(43) Pub. Date: Jan. 16, 2014

(54) Cutting Device for Liquid Crystal Substrate and Cutter Monitoring Method Thereof

(71) Applicants: Haibo Huang, Shenzhen (CN); Tsung-i Hung, Shenzhen (CN); Hongtao Deng, Shenzhen (CN)

(72) Inventors: Haibo Huang, Shenzhen (CN); Tsung-i Hung, Shenzhen (CN); Hongtao Deng, Shenzhen (CN)

(73) Assignee: SHENZHEN CHINA STAR OPTOELECTRONICS TECHNOLOGY CO. LTD., Shenzhen (CN)

(21) Appl. No.: 13/634,877

(22) PCT Filed: Jul. 26, 2012
(86) PCT No.: PCT/CN12/79162

§ 371 Date: Sep. 14, 2012

(30) Foreign Application Priority Data
Jul. 11, 2012 (CN) 201210239178.2

(51) Int. Cl. B26D 7/27; B26D 3/00

(52) U.S. Cl. CPC B26D 7/27; B26D 3/00
USPC 83/13; 83/522.13

(57) ABSTRACT

The present invention provides a cutting device for liquid crystal substrate and cutting monitoring method thereof. The monitoring method includes: using a plurality of cutters to cut a liquid crystal substrate into a plurality of liquid crystal panels; inspecting respective cutting precision data of different cutting edges of a same liquid crystal panel; summarizing cutting precision data of liquid crystal panels cut by a same cutter; and monitoring cutting characteristics of cutter according to average, maximum and/or minimum of the summarized cutting precision data. Through associating cutter and cutting precision data and summarizing the cutting precision data corresponding to a same cutter, the present invention can accurately monitor the cutting characteristics of cutter in real time and can identify the corresponding cutter when abnormal situation of cutting characteristics occurs.

### BACKGROUND OF THE INVENTION

1. Field of the Invention

The present invention relates to the field of liquid crystal substrate techniques, and in particular to a cutting device for liquid crystal substrate and cutter monitoring method thereof.

2. The Related Arts

Liquid crystal display has been widely applied to all types of electronic devices. A main component of liquid crystal display is liquid crystal panel. A liquid crystal panel comprises two transparent substrates (thin film transistor substrate and color filter substrate) and liquid crystal sealed between the two substrates. In manufacturing liquid crystal panel, a cutter is used to cut a large liquid crystal substrate comprising a plurality of liquid crystal panels into a plurality of separate liquid crystal panels of appropriate size. The demand on the cutting precision is very high.

In known technique, the monitoring of cutting precision of liquid crystal panels is to arrange cutting precision data of the eight cutting edges of each liquid crystal panel into eight different charts and then perform monitoring on the cutting precision of each cutting edge of each liquid crystal panel and cutting characteristics of cutter,

However. the know monitoring technique has the following shortcomings: because a same side of different liquid crystal panels is cut by different cutter, monitoring on cutting characteristics of cutter is prone to errors; also, when abnormal situation occurs in cutting precision data of cutting edge of liquid crystal panel, the identification of corresponding cutter is difficult.

Thus, it is desired to have a cutting device for liquid crystal substrate and cutter monitoring method that overcomes the above problems.

### SUMMARY OF THE INVENTION

The technical issue to be addressed by the present invention is to provide a cutting device for liquid crystal substrate and cutter monitoring method thereof, which solves the problems of known technique that monitoring on cutting characteristics of cutter is prone to errors and the identification of corresponding cutter is difficult when abnormal situation occurs in cutting precision data of cutting edge of liquid crystal panel.

The present invention provides a monitoring method for cutter of cutting device for liquid crystal panel, which comprises: using a plurality of cutters to cut a liquid crystal substrate into a plurality of liquid crystal panels; inspecting respective cutting precision data of different cutting edges of a same liquid crystal panel; summarizing cutting precision data of liquid crystal panels cut by a same cutter; and monitoring cutting characteristics of cutter according to average, maximum and/or minimum of the summarized cutting precision data.

According to a preferred embodiment of the present invention, the step of summarizing cutting precision data of liquid crystal panels cut by a same cutter comprises: summarizing cutting precision data of a same liquid crystal panels cut by a same cutter.

According to a preferred embodiment of the present invention, the step of using a plurality of cutters to cut a liquid crystal substrate into a plurality of liquid crystal panels comprises: numbering each of a plurality of cutters; and the step of summarizing cutting precision data of liquid crystal panels cut by a same cutter comprises: associating cutting precision data with corresponding cutter number, and summarizing cutting precision data associated with a same cutter number.

According to a preferred embodiment of the present invention, the step of using a plurality of cutters to cut a liquid crystal substrate into a plurality of liquid crystal panels comprises: using a plurality of cutters to cut a liquid crystal substrate into a plurality of liquid crystal panels in a plurality of cutting processes; and the step of summarizing cutting precision data of liquid crystal panels cut by a same cutter comprises: summarizing cutting precision data of liquid crystal panels cut by a same cutter in a same cutting process.

According to a preferred embodiment of the present invention, the step of using a plurality of cutters to cut a liquid crystal substrate into a plurality of liquid crystal panels comprises: numbering each of a plurality of cutters and numbering each of a plurality of cutting processes; and the step of summarizing cutting precision data of liquid crystal panels cut by a same cutter comprises: associating cutting precision data with corresponding cutter number and corresponding cutting process number, and summarizing cutting precision data associated with a same cutter number and a same cutting process number.

The present invention provides a monitoring method for cutter of cutting device for liquid crystal panel, which comprises: using a plurality of cutters to cut a liquid crystal substrate into a plurality of liquid crystal panels; inspecting cutting precision data of liquid crystal panel; summarizing cutting precision data of liquid crystal panels cut by a same cutter; and monitoring cutting characteristics of cutter according to summarized cutting precision data.

According to a preferred embodiment of the present invention, the step of monitoring cutting characteristics of cutter according to summarized cutting precision data comprises: monitoring cutting characteristics of cutter according to average, maximum and/or minimum of the summarized cutting precision data.

According to a preferred embodiment of the present invention, the step of inspecting cutting precision data of liquid crystal panel comprises: inspecting respective cutting precision data of different cutting edges of a same liquid crystal panel.

According to a preferred embodiment of the present invention, the step of summarizing cutting precision data of liquid crystal panels cut by a same cutter comprises: summarizing cutting precision data of a same liquid crystal panels cut by a same cutter.

According to a preferred embodiment of the present invention, the step of using a plurality of cutters to cut a liquid crystal substrate into a plurality of liquid crystal panels comprises: numbering each of a plurality of cutters; and the step of summarizing cutting precision data of liquid crystal panels cut by a same cutter comprises: associating cutting precision data with corresponding cutter number, and summarizing cutting precision data associated with a same cutter number.

According to a preferred embodiment of the present invention, the step of using a plurality of cutters to cut a liquid crystal substrate into a plurality of liquid crystal panels comprises: using a plurality of cutters to cut a liquid crystal substrate into a plurality of liquid crystal panels in a plurality of cutting processes; and the step of summarizing cutting precision data of liquid crystal panels cut by a same cutter comprises: summarizing cutting precision data of liquid crystal panels cut by a same cutter in a same cutting process.

According to a preferred embodiment of the present invention, the step of using a plurality of cutters to cut a liquid crystal substrate into a plurality of liquid crystal panels comprises: numbering each of a plurality of cutters and numbering each of a plurality of cutting processes; and the step of summarizing cutting precision data of liquid crystal panels cut by a same cutter comprises: associating cutting precision data with corresponding cutter number and corresponding cutting process number, and summarizing cutting precision data associated with a same cutter number and a same cutting process number.

The present invention provides a cutting device for liquid crystal substrate, which comprises: a plurality of cutters, for cutting a liquid crystal substrate into a plurality of liquid crystal panels; an inspection device, for inspecting cutting precision data of liquid crystal panel; a processing device, for summarizing cutting precision data of liquid crystal panels cut by a same cutter; and monitoring cutting characteristics of cutter according to summarized cutting precision data.

According to a preferred embodiment of the present invention, each of the plurality of cutters is assigned a cutter number, the processing device associates cutting precision data with corresponding cutter number and summarizes cutting precision data associated with a same cutter number.

According to a preferred embodiment of the present invention, the plurality of cutters cuts a liquid crystal substrate into a plurality of liquid crystal panels in a plurality of cutting processes, each of the plurality of cutters is assigned a cutter number, each of the plurality of cutting processes is assigned a cutting process number, the processing device associates cutting precision data with corresponding cutter number and corresponding cutting process number, and summarizes cutting precision data associated with a same cutter number and a same cutting process number.

The efficacy of the present invention is that to be distinguished from the state of the art. Through associating cutter and cutting precision data and summarizing the cutting precision data corresponding to a same cutter, the present invention can accurately monitor the cutting characteristics of cutter in real time and can identify the corresponding cutter when abnormal situation of cutting characteristics occurs.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort, In the drawings:

FIG. 1 is a flowchart of the cutter monitoring method of cutting device for liquid crystal substrate according to the present invention; and

FIG. 2 is a schematic view showing the structure of the cutting device for liquid crystal substrate according to the present invention.

### DETAILED DESCRIPTION OF THE PREFERRED EMBODIMENTS

The following description of the drawings and embodiments of the present invention.

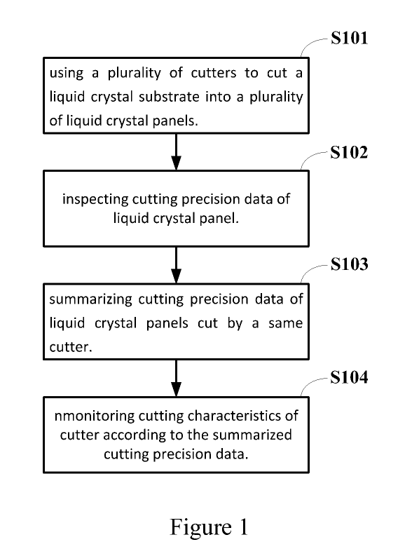

FIG. 1 is a flowchart of the cutter monitoring method of cutting device for liquid crystal substrate according to the present invention. As shown in FIG. 1, the cutter monitoring method comprises the following steps.

Step S101: using a plurality of cutters to cut a liquid crystal substrate into a plurality of liquid crystal panels.

In step S101, before cutting process, each of the plurality of cutters is assigned a cutter number. Preferably, when a plurality of cutting processes is required to use the cutters to cut the liquid crystal substrate into a plurality of liquid crystal panels, each of the plurality of cutting processes is further assigned a cutting process number. Further preferably, each of the liquid crystal substrates and the liquid crystal panels is also assigned a corresponding liquid crystal substrate number and a liquid crystal panel number respectively.

Step S102: inspecting cutting precision data of liquid crystal panel.

In step S102, after cutting process, cutting precision data of different cutting edges of a same liquid crystal panel are inspected and recorded: that is, cutting precision data of different cutting edges of each of the plurality of liquid crystal panels are inspected.

Step S103: summarizing cutting precision data of liquid crystal panels cut by a same cutter.

In step S103, cutting precision data of each liquid crystal panels are summarized first and then each cutting precision data are associated with cutter number of corresponding cutter. Then, the cutting precision data of liquid crystal panels cut by a same cutter are summarized. Preferably, when the plurality of cutters needs to go through a plurality of cutting processes to cut a liquid crystal substrate into a plurality of liquid crystal panels, each cutting precision datum is associated respectively with cutter number of corresponding cutter and cutting process number of corresponding cutting process, and the cutting precision data associated with a same cutter number and a same cutting process number are summarized to achieve summarizing cutting precision data of liquid crystal panels cut by a same cutter in a same cutting process. Further preferably, each cutting precision datum can also be associated with a liquid crystal substrate number of corresponding liquid crystal substrate and a liquid crystal panel of corresponding liquid crystal panel so as to achieve summarizing cutting precision data of each liquid crystal panel of a same liquid crystal substrate cut by a same cutter.

Step S104: monitoring cutting characteristics of cutter according to the summarized cutting precision data.

In step S104, the monitoring of cutting characteristics of cutter can be based on average, maximum and/or minimum of the summarized cutting precision data. For example, the monitoring of cutting characteristics of cutter can be based on average and maximum of the summarized cutting precision data, or based on average and minimum of the summarized cutting precision data. When one or more values in the summarized result is over a default threshold, the cutting characteristics of the cutter are considered failing to meet the cutting precision requirements, and thus the cutter needs to be tuned or replaced.

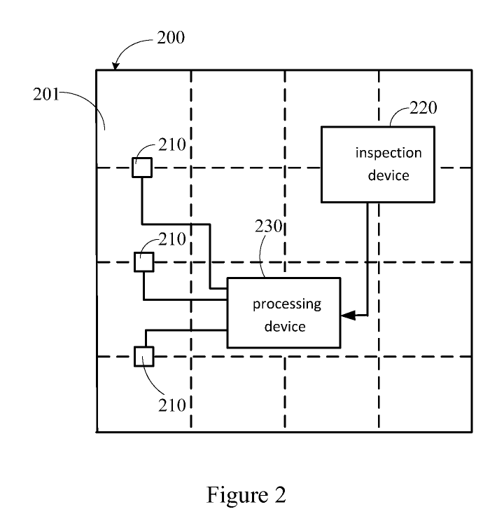

FIG. 2 is a schematic view showing the structure of the cutting device for liquid crystal substrate according to the present invention. As shown in FIG. 2, the cutting device for liquid crystal substrate comprises a plurality of cutters 210, an inspection device 220 and a processing device 230.

In the instant embodiment, the plurality of cutters 210 is for cutting a liquid crystal substrate 200 into a plurality of liquid crystal panels 201. Inspection device 220 and processing device 230 are for inspecting cutting precision data of liquid crystal pane, summarizing cutting precision data of liquid crystal panels 201 cut by a same cutter 210, and monitoring cutting characteristics of cutter 210 according to summarized cutting precision data. Furthermore, processing device 230 is connected to the plurality of cutters 210 to control the cutting processes of cutters 210 and receive feedback data of cutters 210.

The operation theory of cutting device for liquid crystal substrate of the present invention is: before cutting process, a cutter number is assigned to each of the plurality of cutters 210. Preferably, a cutting process number is also assigned to each cutting process of a plurality of cutting processes using cutters 210 to cut liquid crystal substrate 200 into a plurality of liquid crystal panels 201. After cutting process, inspection device 220 inspects cutting precision data of different cutting edges of each liquid crystal panel 201. Processing device 230 summarizes the cutting precision data, associates each cutting precision data with cutter number of corresponding cutter 210, and summarizes cutting precision data associated with a same cutter 210. When a plurality of cutters 210 is used in a plurality of cutting processes to cut liquid crystal substrate 200 into a plurality of liquid crystal panels 201, processing device 230 associates each cutting precision data with cutter number of corresponding cutter 210 and cutting process number of corresponding cutting process, and summarizes cutting precision data associated with a same cutter 210 and a same cutting process number.

Finally, processing device 230 monitors cutting characteristics of cutter 210 based on the summarized cutting precision data. For example, processing device 230 monitors cutting characteristics of cutter 210 based on average, maximum and/or minimum of the summarized cutting precision data.

In the instant embodiment, it is preferably to monitor cutting characteristics of cutter 210 based on average, maximum and/or minimum of the summarized cutting precision data. In other embodiments, the monitoring of cutting characteristics of cutter 210 can be based on average and maximum of the summarized cutting precision data, or based on average and minimum of the summarized cutting precision data. When one or more values in the summarized result is over a default threshold, the cutting characteristics of cutter 210 are considered failing to meet the cutting precision requirements, and thus cutter 210 needs to be tuned or replaced.

In summary, through associating cutter and cutting precision data and summarizing the cutting precision data corresponding to a same cutter, the present invention can accurately monitor the cutting characteristics of cutter in real time and can identify the corresponding cutter when abnormal situation of cutting characteristics occurs.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A monitoring method for cutter of cutting device for liquid crystal panel, which comprises:
using a plurality of cutters to cut a liquid crystal substrate into a plurality of liquid crystal panels;
inspecting respective cutting precision data of different cutting edges of a same liquid crystal panel;
summarizing cutting precision data of liquid crystal panels cut by a same cutter; and
monitoring cutting characteristics of cutter according to average, maximum and/or minimum of the summarized cutting precision data.

2. The monitoring method for cutter as claimed in claim 1, characterized in that the step of summarizing cutting precision data of liquid crystal panels cut by a same cutter comprises: summarizing cutting precision data of a same liquid crystal panels cut by a same cutter.

3. The monitoring method for cutter as claimed in claim 1, characterized in that the step of using a plurality of cutters to cut a liquid crystal substrate into a plurality of liquid crystal panels comprises: numbering each of a plurality of cutters; and the step of summarizing cutting precision data of liquid crystal panels cut by a same cutter comprises: associating cutting precision data with corresponding cutter number, and summarizing cutting precision data associated with a same cutter number.

4. The monitoring method for cutter as claimed in claim 1, characterized in that the step of using a plurality of cutters to cut a liquid crystal substrate into a plurality of liquid crystal panels comprises: using a plurality of cutters to cut a liquid crystal substrate into a plurality of liquid crystal panels in a plurality of cutting processes: and the step of summarizing cutting precision data of liquid crystal panels cut by a same cutter comprises: summarizing cutting precision data of liquid crystal panels cut by a same cutter in a same cutting process.

5. The monitoring method for cutter as claimed in claim 4, characterized in that the step of using a plurality of cutters to cut a liquid crystal substrate into a plurality of liquid crystal panels comprises: numbering each of a plurality of cutters and numbering each of a plurality of cutting processes; and the step of summarizing cutting precision data of liquid crystal panels cut by a same cutter comprises: associating cutting precision data with corresponding cutter number and corresponding cutting process number, and summarizing cutting precision data associated with a same cutter number and a same cutting process number.

6. A monitoring method for cutter of cutting device for liquid crystal panel, which comprises:
using a plurality of cutters to cut a liquid crystal substrate into a plurality of liquid crystal panels;
inspecting cutting precision data of liquid crystal panel;
summarizing cutting precision data of liquid crystal panels cut by a same cutter; and
monitoring cutting characteristics of cutter according to the summarized cutting precision data.

7. The monitoring method for cutter as claimed in claim 6, characterized in that the step of monitoring cutting characteristics of cutter according to summarized cutting precision data comprises: monitoring cutting characteristics of cutter according to average, maximum and/or minimum of the summarized cutting precision data.

8. The monitoring method for cutter as claimed in claim 6, characterized in that the step of inspecting cutting precision data of liquid crystal panel comprises: inspecting respective cutting precision data of different cutting edges of a same liquid crystal panel.

9. The monitoring method for cutter as claimed in claim 6, characterized in that the step of summarizing cutting precision data of liquid crystal panels cut by a same cutter comprises: summarizing cutting precision data of a same liquid crystal panels cut by a same cutter.

10. The monitoring method for cutter as claimed in claim 6, characterized in that the step of using a plurality of cutters to cut a liquid crystal substrate into a plurality of liquid crystal panels comprises: numbering each of a plurality of cutters; and the step of summarizing cutting precision data of liquid crystal panels cut by a same cutter comprises: associating cutting precision data with corresponding cutter number, and summarizing cutting precision data associated with a same cutter number.

11. The monitoring method for cutter as claimed in claim 6, characterized in that the step of using a plurality of cutters to cut a liquid crystal substrate into a plurality of liquid crystal panels comprises: using a plurality of cutters to cut a liquid crystal substrate into a plurality of liquid crystal panels in a plurality of cutting processes; and the step of summarizing cutting precision data of liquid crystal panels cut by a same cutter comprises: summarizing cutting precision data of liquid crystal panels cut by a same cutter in a same cutting process.

12. The monitoring method for cutter as claimed in claim 11, characterized in that the step of using a plurality of cutters to cut a liquid crystal substrate into a plurality of liquid crystal panels comprises: numbering each of a plurality of cutters and numbering each of a plurality of cutting processes; and the step of summarizing cutting precision data of liquid crystal panels cut by a same cutter comprises: associating cutting precision data with corresponding cutter number and corresponding cutting process number, and summarizing cutting precision data associated with a same cutter number and a same cutting process number.

13. A cutting device for liquid crystal substrate, which comprises:
a plurality of cutters, for cutting a liquid crystal substrate into a plurality of liquid crystal panels;
an inspection device, for inspecting cutting precision data of liquid crystal panel; and
a processing device, for summarizing cutting precision data of liquid crystal panels cut by a same cutter; and monitoring cutting characteristics of cutter according to summarized cutting precision data.

14. The cutting device for liquid crystal substrate as claimed in claim 13, characterized in that each of the plurality of cutters is assigned a cutter number, the processing device associates cutting precision data with corresponding cutter number and summarizes cutting precision data associated with a same cutter number.

15. The cutting device for liquid crystal substrate as claimed in claim 13, characterized in that the plurality of cutters cuts a liquid crystal substrate into a plurality of liquid crystal panels in a plurality of cutting processes, each of the plurality of cutters is assigned a cutter number, each of the plurality of cutting processes is assigned a cutting process number, the processing device associates cutting precision data with corresponding cutter number and corresponding cutting process number, and summarizes cutting precision data associated with a same cutter number and a same cutting process number.
